(19) United States
(12) Patent Application Publication
(10) Pub. No.: US 2021/0347678 A1
(43) Pub. Date: Nov. 11, 2021

(54) Innovative label with vitreous base, preferably for glass containers such as bottles

(71) Applicant: Etiké IP S.r.l., Salerno (IT)

(72) Inventor: Onofrio Acone, Baronissi (IT)

(21) Appl. No.: 17/268,589

(22) PCT Filed: Aug. 9, 2019
(86) PCT No.: PCT/IB2019/056786

§ 371 Date: Feb. 15, 2021

(30) Foreign Application Priority Data
Aug. 29, 2018 (IT) 102018000008225

(51) Int. Cl. C03C 3/083; C03B 19/06; G09F 3/02

(52) U.S. Cl. CPC C03C 3/083; G09F 2003/0273; G09F 3/02; C03B 19/06

(57) ABSTRACT

A label for glass containers for beverages in general, preferably for bottles, has composition that includes glass and provides increased impact and compression resistance, and is fully recyclable. A method of making such label and a use thereof are also disclosed.

### SCOPE OF THE INVENTION

The present invention relates to the technical field inherent in the labelling of glass containers for beverages in general, preferably bottles. In particular, it relates to an improved type of glass-based label, with increased impact and compression resistance and which is also fully recyclable.

The present invention also relates to the relative method of making said label and the use thereof.

### OVERVIEW OF THE PRIOR ART

The patent application with international publication number WO2010/029402 A1 has long been known.

This publication describes a label for bottles consisting of a moulded ceramic material, partially or completely covered with enamel, which bears a writing or drawing in high or low relief thus giving a three-dimensional effect.

This label has proven to have excellent aesthetic characteristics, as well as better durability and resistance to the effects of the environment (for example, humidity) than traditional paper labels.

A drawback linked to this type of label consists, however, in the fact that, being made of ceramic material, it is fragile, which means it is not very resistant to impact and compression. In addition, the covering enamel tends to flake or peel off over time. Finally, above all, said label is not recyclable, thus making the same bottle to which it has been applied not recyclable in most cases.

All this has a strongly negative environmental impact. In fact, the need to carry out separate collection of waste is increasingly widespread, and even compulsory in several cities, in Italy and abroad, so much so that for some time now special bins have been used for the specific collection of glass.

Patent application with international publication number WO2016/016763 A1 is equally well-known.

This publication describes a bottle label consisting essentially of a glass-based material in which said glass-based material includes (a) an appropriate quantity of glass dust from the shattering of any type of glass and (b) an appropriate quantity of atomized glass dust, that is to say, consisting of very small expanded spheres.

Compared with WO2010/029402 A1, said label, in addition to being long-lasting, resistant to environmental attacks and endowed with excellent aesthetic characteristics, has also proved to be more ecologically compatible, that is to say, recyclable together with the bottle on which it is applied.

However, this label is also fragile, that is to say, not very resistant to impact and compression. Moreover, also in this case the covering enamel tends to flake or peel off over time.

### TECHNICAL PROBLEM

Therefore, the sector still needs to have a new type of label for glass containers, preferably bottles, which, in addition to being equipped with the advantageous characteristics of the labels described above (long-lasting, resistant to environmental conditions, washable, reusable, with clearly visible three-dimensional, aesthetically excellent characters/drawings), is also ecologically compatible (i.e. completely recyclable together with the bottle on which it is applied), and resistant to impact and compression (i.e., not fragile), and in which any possible enamelled portion is not subjected to flaking or peeling off over time.

### SUMMARY OF THE INVENTION

It is therefore an object of this invention to provide a new type of label for containers, preferably in glass and even more preferably glass bottles, that solves all the aforementioned technical problems.

In particular, it is an object of this invention to provide a new type of label that, in addition to being endowed with the advantageous characteristics of the labels described above, is also completely ecologically compatible, resistant to impact and compression and in which any possible enamel portion is not subjected to flaking or peeling off over time.

These and other objects are therefore obtained with a label, for example for glass containers such as bottles, more particularly for bottles of wine or sparkling wine, according to claim 1.

This label, according to the invention, is constituted by a material comprising, or consisting of, at least one mixture, or dry dough, of effective quantities of:
silicon;
alumina;
sodium oxide.

In this way all the aforementioned technical drawbacks are easily solved.

In particular, as also described below, this label is much more resistant to impact and compression and with significantly shorter firing times.

Advantageously in said mixture:
silicon may be present in the form of silica, SiO₂, said silica being in pure form of a white crystalline powder, characterized by an average density of about 2.2 gr/cm³;
alumina may be present in the form of Al₂O₃, said Al₂O₃ preferably being in white solid granular form, characterized by an average density of about 3.94 g/cm³;
sodium oxide may be present as Na₂O, said Na₂O being in white crystalline solid form, characterized by an average density of about 2.27 gr/cm³.

Advantageously in said mixture:
silica can be present in an effective amount of 66% to 76% by weight, with respect to the total weight of the mixture;
alumina can be present in an effective amount of between 14% and 24% by weight, with respect to the total weight of the mixture;
sodium oxide can be present in an effective amount of 4% to 11% by weight, with respect to the overall weight of the mixture.

Advantageously, in said mixture:
silica can be present in an amount of 71% by weight, with respect to the total weight of the mixture;
alumina can be present in an amount of 19% by weight, with respect to the total weight of the mixture;
sodium oxide can be present in an amount of 10% by weight, with respect to the total weight of the mixture.

Advantageously, said mixture further comprises effective amounts of:
potassium oxide, and/or
titanium dioxide.

Advantageously, potassium oxide can for example be present as K₂O, said K₂O being in the form of a colourless crystalline solid, characterized by an average density of about 2.35 g/cm³.

Advantageously, titanium dioxide may be present as TiO₂, said TiO₂ being in the form of a crystalline solid that is colourless or tending to white, characterized by an average density of about 4.23 gr/cm³.

Advantageously, in said mixture:
potassium oxide can be present in an effective amount of 1% to 3% by weight, with respect to the total weight of the mixture;
titanium dioxide can be present in an effective amount of 0.6% to 1.4% by weight, with respect to the total weight of the mixture.

Advantageously, in said mixture:
silica can be present in an amount of 71% by weight, with respect to the total weight of the mixture;
alumina can be present in an amount of 19% by weight, with respect to the total weight of the mixture;
sodium oxide can be present in an amount of 7% by weight, with respect to the total weight of the mixture;
potassium oxide can be present in an amount of 2% by weight, with respect to the total weight of the mixture;
titanium dioxide can be present in an amount of 1% by weight, with respect to the total weight of the mixture.

Advantageously, said material can further comprise an effective amount of one or more silica- or polymer-based binder compounds, potassium silicate, sodium silicate, or sodium carbonate, capable of helping the components of the described mixture to bind with one another and to compact in a stable and homogeneous way during the subsequent pressing and firing phases.

Advantageously, said material can further comprise an effective amount of one or more additive compounds, colouring pigments, siliceous crystals, or natural oxides.

Advantageously, this label has a breaking modulus of more than 500 kg/cm².

In the same manner, advantageously, a process is described here for making a label, comprising the steps of:

Providing a mixture, or dry dough, consisting of an effective amount of:
silicon;
alumina;
sodium oxide;

inside a mould of a mechanical press;
Compressing said mixture or dough in a way that compacts it and forms a desired label;
Extracting the label;
Subjecting said label to final firing.

Further advantages may be derived from the dependent claims.

Advantageously, the desired label can reproduce elements in high and/or low relief, for example drawings, logos, writings in general.

Advantageously, the label obtained can be coated with enamel and/or appropriate colour to cover at least the high and/or low relief elements reproduced on the label.

Advantageously, said final firing step can be carried out at a temperature ranging from about 900° C. to about 1150° C., for example for a time of about 2 hours.

Also described here is the use of a label as described above and produced for the labelling of glass containers for beverages, preferably bottles for wines and sparkling wines.

### DETAILED DESCRIPTION OF THE INVENTION

The label for glass containers, preferably bottles, according to this invention is constituted by a (vitreous) material comprising, or consisting of, a mixture, or a dry dough, of effective quantities of:
silicon;
alumina;
sodium oxide.

In said mixture, or dry dough:

silicon is present in the form of silica, SiO₂, or silicon dioxide; said silica being preferably in pure white crystalline powder form, characterized by an average density of about 2.2 gr/cm³ (on the Mohs scale, it is considered a hard component and is also a particularly refractory material);

alumina is present in the form of Al₂O₃, or di-aluminium trioxide; said Al₂O₃ preferably being in white solid granular form, characterized by an average density of about 3.94 g/cm³ (its most important technical property is its high resistance to acids and its high thermal conductivity);

sodium oxide is present as Na₂O, or disodium oxide; said Na₂O being in white crystalline solid form, characterized by an average density of about 2.27 gr/cm³ (sodium oxide is known and used in the art, among other things, to generally lower the melting temperature of glass).

Preferably, in said mixture, or dry dough: silicon/silica is present in an effective amount of 66% to 76% by weight, with respect to the total weight of the mixture; preferably, from 68% to 74% by weight; more preferably, from 69% to 73% by weight; even more preferably, from 70% to 72% by weight;

alumina is present in an effective amount of between 14% and 24% by weight, with respect to the total weight of the mixture; preferably from 16% to 22% by weight; more preferably, from 17% to 21% by weight; even more preferably, from 18% to 20% by weight;

sodium oxide is present in an effective amount of 4% to 11% by weight, with respect to the total weight of the mixture; preferably from 5% to 10% by weight; more preferably, from 6% to 9% by weight; even more preferably, from 6% to 8% by weight.

In one embodiment of the invention, in said mixture:

silicon/silica is present in an amount of 71% by weight, with respect to the total weight of the mixture;

Alumina is present in an amount of 19% by weight, with respect to the total weight of the mixture;

Sodium oxide is present in an amount of 10% by weight, with respect to the total weight of the mixture.

Preferably, said mixture or dry dough further comprises effective amounts of:
potassium oxide, and/or
titanium dioxide;

in which:

Potassium oxide is present as K₂O, or di-potassium oxide; said K₂O being in colourless crystalline solid form, characterized by an average density of about 2.35 g/cm₃;

Titanium dioxide is present as TiO₂, or titanium dioxide; said TiO₂ being in crystalline solid form, colourless or tending to white, characterized by an average density of about 4.23 gr/cm³ (also used in general in the art to increase resistance to acid agents).

In this preferred mixture, or dry dough:

potassium oxide is present in an effective amount of 1% to 3% by weight, with respect to the total weight of the mixture; preferably, from 1.25% to 2.75% by weight; more preferably, from 1.5% to 2.5% by weight; even more preferably, from 1.75% to 2.25% by weight;

titanium dioxide is present in an effective amount of 0.6% to 1.4% by weight, with respect to the total weight of the mixture; preferably, from 0.7% to 1.3% by weight; more preferably, from 0.8% to 1.2% by weight; even more preferably, from 0.9% to 1.1% by weight.

In a particularly preferred embodiment of the invention, in said mixture:

silicon/silica is present in an amount of 71% by weight, with respect to the total weight of the mixture;

alumina is present in an amount of 19% by weight, with respect to the total weight of the mixture;

sodium oxide is present in an amount of 7% by weight, with respect to the total weight of the mixture;

potassium oxide is present in an amount of 2% by weight, with respect to the total weight of the mixture;

titanium dioxide is present in an amount of 1% by weight, with respect to the total weight of the mixture.

The material comprising the mixture, or dry dough, described above, can further comprise an effective amount of one or more silica- or polymer-based binding compounds (by way of a non-limiting example, potassium silicate, sodium silicate, or sodium carbonate) which can advantageously help the components of the above mixture to bind to one another and to compact in a stable and homogeneous manner during the subsequent phases of pressing and firing.

To the material comprising the mixture, or dry dough, of this invention, described above, other additives, for example dye pigments, can possibly be further added if desired, in order to adapt the final vitreous dough to various commercial necessities. Said additives are freely selected from those known and commonly used in the glass processing industry, for example siliceous crystallines or natural oxides, and are normally within the scope of knowledge of those skilled the art.

The materials described above are mixed (preferably using a known dry powder mixer, for example, such as those sold by the Eirich Company or by the CIMMA Company) according to methods commonly known and used in the field, in such a way as to obtain the final composition (especially, the mixture) of the invention, ready to be used in the subsequent steps for the preparation of the labels.

The aforesaid final composition, or mixture of the invention, ready for use, visually is in the form of a uniform, colourless or variously coloured powder, with an overall humidity of between 4% and 15% by weight, with respect to the overall weight of the composition, preferably, from 10% to 12% by weight; more preferably, from 5.7% to 6% by weight.

The label of this invention can be made either with a certain appropriate radius of curvature or in a flat shape. In this way it can adapt to any conformation of the surface to which it is applied.

The label can therefore be concave, convex or flat and in any case be shaped according to suitable shapes, curvatures and different dimensions.

The label then bears characters and/or writings and/or lines and/or a drawing and/or a logo, for example, in high and/or low relief.

A layer of enamel or a colouring, an external protective coating in any case, may be distributed over said label, in particular at least covering the characters in high/low relief.

The enamel is selected from those well-known and commonly used in the field and is applied with equipment and application methods well-known and used in the glass-making sector.

The process for producing the label of this invention substantially consists of a process for moulding and firing the substantially glass-based mixture/dough of this invention as is known and generally applied in the field. In this respect, explicit reference is made here to the method for producing a glass-based label described in WO2016/016763 A1, which is also applied advantageously with some characterizing variants which will be described below, to the production of the label of the invention. Consequently, WO2016/016763 A1 is here incorporated in its entirety as a specific reference.

By way of a summary and non-limiting example, and again with specific reference to the teaching of WO2016/016763 A1, the process for making a label of this invention comprises at least the steps of:
Providing an effective quantity of the (vitreous) material comprising, or consisting of, the mixture of this invention, previously described, inside a suitable mould (such as, for example, a receiving alveolus) of a suitable mechanical press;
Compressing said (vitreous) material in such a way as to compact it and to form a desired label reproducing elements in high and/or low relief;
Extracting the label obtained and coating it with enamel and/or appropriate colour to cover at least the characters in high and/or low relief reproduced on the label;
Finally firing said label obtained from the previous step.

The fundamental characteristic of the process of this invention lies in the fact that the final firing of the label is carried out at a temperature higher by at least 300° C. with respect to WO2016/016763 A1, that is to say, at a temperature generally ranging from about 900° C. to about 1150° C.; preferably, from 900° C. to 1200° C.; more preferably, at about 1200° C. in total; even more preferably, at 1200° C. in total.

Furthermore, the preferred firing time is also much lower than that of WO2016/016763 A1; in fact, the final firing time of the label according to the process of this invention is of about 2 hours.

All that has been described in this document has made it possible to considerably improve the breaking modulus of the label of this invention, with respect to that of the label of WO2016/016763 A1. In fact, said breaking modulus has increased from about 280 kg/cm² to more than 500 kg/cm², preferably >550 kg/cm²; more preferably >600 kg/cm²; in a particularly preferred embodiment, of about 660 kg/cm²; more preferably, of 660 kg/cm².

This fact has shown that the label of this invention is much more resistant to impacts and compression and with significantly lower firing times.

Furthermore, unexpectedly the label of this invention has been shown to possess an absorption with respect to liquids equal to about 0.3% (in comparison, the label of WO2016/016763 A1 absorbed 7%). This fact has also made it possible to obtain better adhesion and better compactness of the colours and/or enamels applied to the surface of the label. This detail should not be underestimated as in the case of known labels made of ceramic or glass, over time the enamel tended to flake/peel away from the body of the label whereas, advantageously, with the label of this invention, this problem no longer arised.

Finally, the recyclability of the label of this invention has also resulted significantly improved with respect to the known glass labels. For this purpose, a fusion test and subsequent optical microscope observation of the fusion product were carried out on a green glass bottle bearing a label made with the composition of this invention. The purpose of the test was to check for the presence of stones (non-recyclable) after the bottle was fused together with the label.

For test purposes, the bottle and label were reduced to fragments of the size of 1-2 cm. The fragments were then melted in an electric furnace using a silica-alumina crucible at an initial temperature of 1200° C. After that temperature was raised to 1550° C. in a time of one hour and held at this level for two hours. Then the temperature was allowed to drop to 1450° C. and held at this level for an hour. Finally, the molten glass was poured onto a steel plate, annealed at 540° C. in an electric oven and finally cooled slowly to room temperature. The glass obtained was carefully observed under an optical microscope; no stones were found in the glass sample. Based on this result it was possible to conclude that the label dissolved completely in the glass of the bottle without forming non-recyclable impurities, thus confirming the complete and total recyclability of the label of the invention.

### INDUSTRIAL APPLICABILITY

In view of all the above, it is possible to conclude that the label of this invention has solved the technical problem of breakage of the previous glass labels, being more resistant to impact and compression, and to absorption. Moreover, it has also found to be much better in terms of complete recyclability, and in terms of permanence of the enamel and/or colour applied to it, without any undesired formation of flakes and peeling of same.

The invention claimed is:

1. A label for glass containers made of a material comprising:
a mixture, or dry dough, containing effective amounts of:
silicon;
alumina; and
sodium oxide.

2. The label, according to claim 1, wherein in said mixture:
silicon is present as silica having a SiO₂ composition, said silica being in pure white crystalline powder form, with an average density of about 2.2 g/cm³;
alumina is present as Al₂O₃, said Al₂O₃ being in white solid granular form, with an average density of about 3.94 g/cm³; and
sodium oxide is present as Na₂O, said Na₂O being in white crystalline solid form, with an average density of about 2.27 g/cm³.

3. The label, according to claim 1, wherein in said mixture:
silica is present in an effective amount of 66% to 76% by weight, with respect to a total weight of the mixture;
alumina is present in an effective amount of between 14% and 24% by weight, with respect to the total weight of the mixture; and
sodium oxide is present in an effective amount of 4% to 11% by weight, with respect to the total weight of the mixture.

4. The label, according to claim 1, wherein in said mixture:
silica is present in an amount of 71% by weight, with respect to a total weight of the mixture;
alumina is present in an amount of 19% by weight, with respect to the total weight of the mixture; and
sodium oxide is present in an amount of 10% by weight, with respect to the total weight of the mixture.

5. The label, according to claim 1, wherein said mixture further comprises effective amounts of:
potassium oxide, and/or
titanium dioxide;
wherein:
potassium oxide is present as K₂O, said K₂O being in colorless crystalline solid form, with an average density of about 2.35 g/cm³; and
titanium dioxide is present as TiO₂, said TiO₂ being in colorless, or white translucent, crystalline solid form, with an average density of about 4.23 g/cm³.

6. The label, according to claim 5, wherein in said mixture:
potassium oxide is present in an effective amount of 1% to 3% by weight, with respect to a total weight of the mixture; and
titanium dioxide is present in an effective amount of between 0.6% and 1.4% by weight, with respect to the total weight of the mixture.

7. The label, according to claim 5, wherein in said mixture:
silica is present in an amount of 71% by weight, with respect to a total weight of the mixture;
alumina is present in an amount of 19% by weight, with respect to the total weight of the mixture;
sodium oxide is present in an amount of 7% by weight, with respect to the total weight of the mixture;
potassium oxide is present in an amount of 2% by weight, with respect to the total weight of the mixture; and
titanium dioxide is present in an amount of 1% by weight, with respect to the total weight of the mixture.

8. The label, according to claim 1, wherein the label has a breaking modulus greater than 500 kg/cm².

9. The label according to claim 1, wherein the label has a radius of curvature such as to adapt to a conformation of a surface of a container, to which the label is applied.

10. The label according to claim 1, wherein the label comprises characters in high or low relief.

11. A method for making a label for glass containers, comprising the steps of:
providing an effective quantity of the mixture according to claim 1, within a mold of a press;
compressing the mixture to compact the mixture and form the label;
extracting the label obtained thereby; and
subjecting the obtained label to final firing.

12. The method according to claim 11, wherein said final firing step is carried out at a temperature ranging from about 900° C. to about 1150° C.

13. The method, according to claim 11, wherein the label is shaped according to a predetermined radius of curvature.
